(19) United States
(12) Patent Application Publication
(10) Pub. No.: US 2004/0150685 A1
(43) Pub. Date: Aug. 5, 2004

(54) Print media handling apparatus and method in inkjet printer

(75) Inventor: Henry G. Wirth, Rochester, NY (US)

Correspondence Address: Milton S. Sales, Patent Legal Staff, Eastman Kodak Company, 343 State Street, Rochester, NY, 14650-2201, US

(73) Assignee: Eastman Kodak Company

(21) Appl. No.: 10/358,848

(22) Filed: Feb. 5, 2003

(51) Int. Cl. B41J 29/38

(52) U.S. Cl. 347/16

(57) ABSTRACT

A print media handling apparatus for controlling print medium-to-printhead spacing during printing on a print medium using an inkjet printhead comprises a flat platen for supporting a print medium in a print zone which is between the flat platen and an inkjet printhead and into which a printing ink is discharged from the printhead to be deposited on successive portions of the print medium as each portion of the print medium is moved through the print zone, and a support for supporting each portion of the print medium after the printing ink is discharged onto that portion of the print medium, and at a height that is higher than at the flat platen in order to prevent each portion of the print medium from bowing in the print zone and possibly against the print head, whereby the print medium-to-printhead spacing during printing is prevented from substantially varying to reduce print quality.

### FIELD OF THE INVENTION

The invention relates generally to print media handling during printing using an ink-type printhead such as an inkjet printhead, and more particularly to an apparatus and method for controlling print medium-to-printhead spacing during printing.

### BACKGROUND OF THE INVENTION

Often, as shown in FIG. 3 of the drawings, a prior art inkjet printer 10 includes an inkjet printhead 12, a flat platen 14 for supporting a print medium 16 in a print zone 18 that is between the platen and the printhead, and some medium advance means such as a pinch roller 20 and a capstan roller 22 that serve to advance successive portions of the print medium through the print zone. The print zone is the space in which printing occurs when ink droplets are discharged from the printhead 12 and onto successive portions of the print medium 16. The ink droplets may be dropped, ejected or otherwise discharged from the printhead.

A problem that can occur as shown in FIG. 3 is that successive portions of the print medium 16 can bow in the print zone 18 and possibly against the printhead 12. This causes the print medium-to-printhead spacing during printing to vary, which reduces print quality as mentioned in prior art U.S. Pat. No. 5,280,283 issued Oct. 13, 1998. In the extreme, the print medium 16 contacts the printhead 12 which causes the ink droplets to smear on the print medium.

### SUMMARY OF THE INVENTION

According to one aspect of the invention, a print media handling apparatus for controlling print medium-to-printhead spacing during printing on a print medium using an inkjet printhead comprises:

a flat platen for supporting a print medium in a print zone which is between the flat platen and an inkjet printhead and into which a printing ink is discharged from the printhead to be deposited on successive portions of the print medium as each portion of the print medium is moved through the print zone; and

a support for supporting each portion of the print medium after the printing ink is discharged onto that portion of the print medium, and at a height that is higher than at the flat platen in order to prevent each portion of the print medium from bowing in the print zone and possibly against the print head, whereby the print medium-to-printhead spacing during printing is prevented from substantially varying to reduce print quality.

According to another aspect of the invention, a print media handling method for controlling print medium-to-printhead spacing during printing on a print medium using an ink-type printhead comprises:

advancing a print medium through a print zone in which printing occurs using an ink-type printhead;

supporting a print medium flat in the print zone; and

supporting the print medium when it has emerged from the print zone and at a height that is higher than in the print zone in order to prevent the print medium from bowing in the print zone and possibly against the print head, whereby the print medium-to-printhead spacing during printing is prevented from substantially varying to reduce print quality.

### BRIEF DESCRIPTION OF THE DRAWINGS

FIG. 1 is a perspective view of an inkjet printer which is a preferred embodiment of the invention, depicting a print media handling apparatus and method for controlling print medium-to-printhead spacing during printing;

FIG. 2 is an elevation view in cross-section of the inkjet printer shown in FIG. 1; and

FIG. 3 is an elevation view in cross-section of a prior art printer, depicting bowing of the print medium against the printhead.

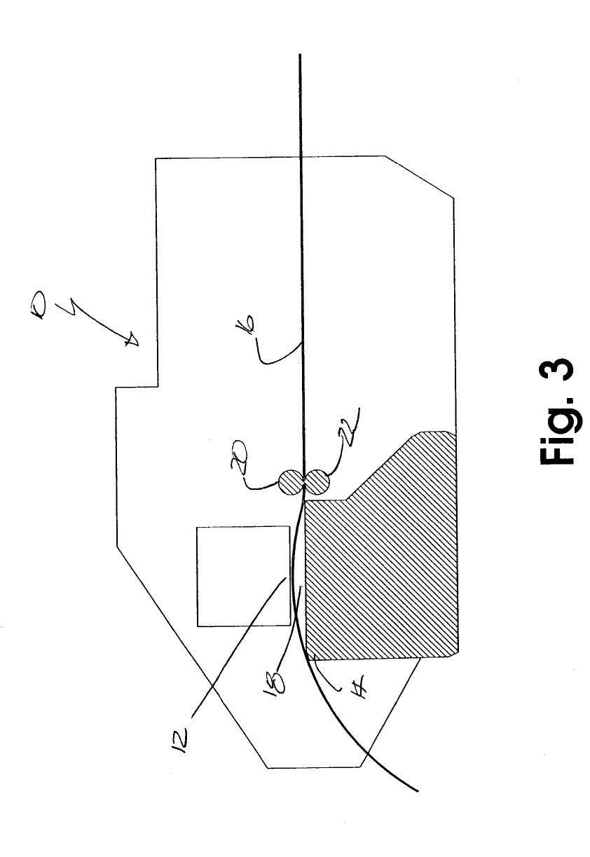

### DETAILED DESCRIPTION OF THE INVENTION

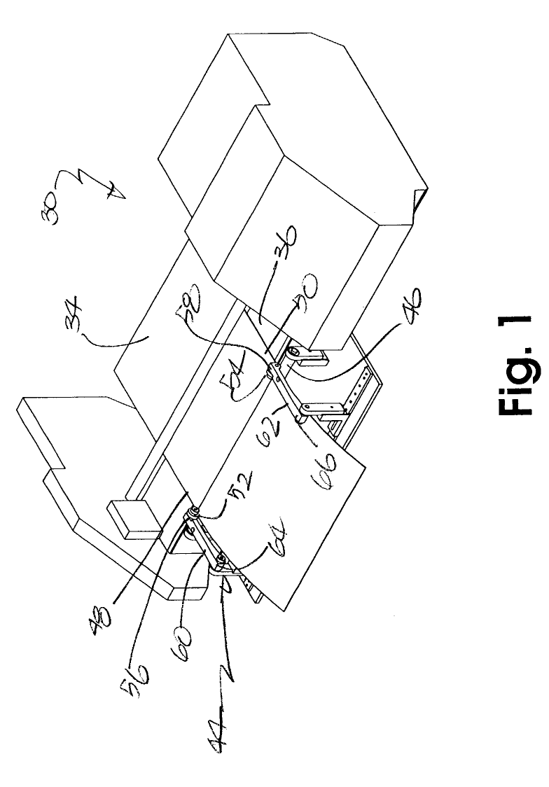

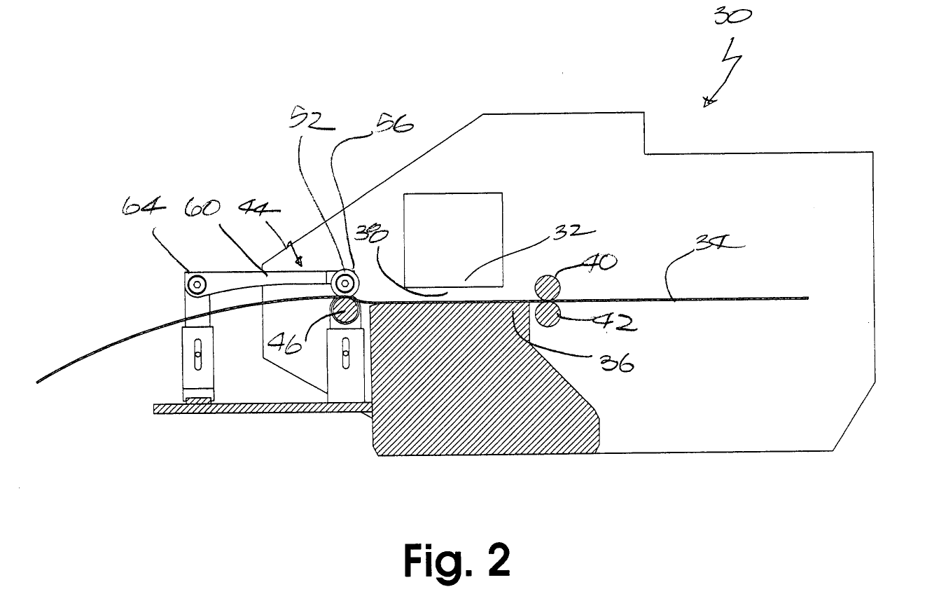

As shown in FIGS. 1 and 2 of the drawings, an inkjet printer 30 comprises:

an inkjet printhead 32 for discharging ink droplets (not shown) for printing on a print medium 34;

a flat platen 36 for supporting the print medium in a print zone 38 which is between said flat platen and the printhead and into which the ink droplets are discharged from the printhead to be deposited on successive portions of the print medium as each portion of the print medium is moved through the print zone;

a pinch roller 40 and a motor-driven capstan roller 42 for advancing successive portions of the print medium through the print zone (to the left in FIG. 2); and

a support 44 for supporting each portion of the print medium after the ink droplets are discharged onto that portion of the print medium, for example when each portion has emerged from the print zone, and at a height that is higher than the print medium is supported on the flat platen (i.e. in the print zone) in order to prevent each portion of the print medium from bowing in the print zone and possibly against the print head, whereby a print medium-to-printhead spacing during printing is prevented from substantially varying to reduce print quality.

The support 44 includes a motor-driven support roller 46 that underlies each portion of the print medium 34 from one non-printed longitudinal edge area 48 to another non-printed longitudinal edge area 50 of the print medium and respective coaxial bearing rollers 52 and 54 that press the non-printed longitudinal edge areas of each portion of the print medium against the support roller. See FIGS. 1 and 2. The bearing rollers 52 and 54 are rotatably mounted at respective ends 56 and 58 of projecting beams 60 and 62 which are pivotally supported at other ends 64 and 66 of the beams. Respective torsion springs (not shown) urge the beams 60 and 62 to pivot clockwise in FIGS. 1 and 2 to cause the bearing rollers 52 and 54 to press the non-printed longitudinal edge areas 48 and 50 of each portion of the print medium 34 against the support roller 46.

The invention has been described in detail with particular reference to certain preferred embodiments thereof, but it will be understood that variations and modifications can be effected within the spirit and scope of the invention.

### Parts List

10. prior art inkjet printer

12. inkjet printhead

14. flat platen

16. print medium

18. print zone

20. pinch roller

22. capstan roller

30. inkjet printer

32. inkjet printhead

34. print medium

36. flat platen

38. print zone

40. pinch roller

42. capstan roller

44. support

46. support roller

48. non-printed longitudinal area

50. non-printed longitudinal area

52. bearing roller

54. bearing roller

56. end

58. end

60. projecting beam

62. projecting beam

64. end

66. end

What is claimed is:

1. A print media handling apparatus for controlling print medium-to-printhead spacing during printing on a print medium using an ink-jet printhead, said print media handling apparatus comprising:
a flat platen for supporting a print medium in a print zone which is between said flat platen and an inkjet printhead and into which a printing ink is discharged from the printhead to be deposited on successive portions of the print medium as each portion of the print medium is moved through said print zone; and
a support for supporting each portion of the print medium after the printing ink is discharged onto that portion of the print medium, and at a height that is higher than at said flat platen in order to prevent each portion of the print medium from bowing in said print zone and possibly against the print head, whereby the print medium-to-printhead spacing during printing is prevented from substantially varying to reduce print quality.

2. A print media handling apparatus as recited in claim 1, wherein said support supports each portion of the print medium when that portion of the print medium has emerged from said print zone.

3. A print media handling apparatus as recited in claim 1, wherein said support includes a support roller that underlies each portion of the print medium from one non-printed longitudinal edge area to another non-printed longitudinal edge area of the print medium and bearing rollers that press the non-printed longitudinal edge areas of each portion of the print medium against said support roller.

4. A print media handling apparatus as recited in claim 3, wherein said bearing rollers are rotatably mounted at respective ends of projecting beams which are pivotally supported at other ends of said beams.

5. A print media handling method for controlling print medium-to-printhead spacing during printing on a print medium using an ink-type printhead, said print media handling method comprising:
advancing a print medium through a print zone in which printing occurs using an ink-type printhead;
supporting a print medium flat in the print zone; and
supporting the print medium when it has emerged from the print zone and at a height that is higher than in the print zone in order to prevent the print medium from bowing in the print zone and possibly against the print head, whereby the print medium-to-printhead spacing during printing is prevented from substantially varying to reduce print quality.

6. A print media handling method for controlling print medium-to-printhead spacing during printing on a print medium using an ink-jet printhead, said print media handling method comprising:
supporting a print medium flat in a print zone into which a printing ink is discharged from an inkjet printhead and onto successive portions of the print medium as each portion of the print medium is moved through the print zone; and
supporting each portion of the print medium after the printing ink is discharged onto that portion of the print medium, and at a height that is higher than in the print zone in order to prevent each portion of the print medium from bowing in the print zone and possibly against the print head, whereby the print medium-to-printhead spacing during printing is prevented from substantially varying to reduce print quality.

7. A print media handling apparatus for controlling print medium-to-printhead spacing during printing on a print medium using an ink-jet printhead, said print media handling method comprising:
means for supporting a print medium flat in a print zone in which printing occurs using an inkjet printhead; and
means for supporting the print medium when it has emerged from the print zone and at a height that is higher than in the print zone in order to prevent the print medium from bowing in the print zone and possibly against the print head, whereby the print medium-to-printhead spacing during printing is prevented from substantially varying to reduce print quality.

8. A print media handling apparatus for controlling print medium-to-printhead spacing during printing on a print medium using an ink-jet printhead, said print media handling method comprising:
means for supporting a print medium flat in a print zone into which a printing ink is discharged from an inkjet printhead and onto successive portions of the print medium as each portion of the print medium is moved through the print zone; and
means for supporting each portion of the print medium after the printing ink is discharged onto that portion of the print medium, and at a height that is higher than in the print zone in order to prevent each portion of the print medium from bowing in the print zone and possibly against the print head, whereby the print medium-to-printhead spacing during printing is prevented from substantially varying to reduce print quality.

9. An inkjet printer comprising:
an inkjet printhead for discharging ink droplets for printing on a print medium;
a flat platen for supporting the print medium in a print zone which is between said flat platen and said printhead and into which the ink droplets are discharged from said printhead to be deposited on successive portions of the print medium as each portion of the print medium is moved through said print zone; and
a support for supporting each portion of the print medium after the ink droplets are discharged onto that portion of the print medium, and at a height that is higher than at said flat platen in order to prevent each portion of the print medium from bowing in said print zone and possibly against said print head, whereby a print medium-to-printhead spacing during printing is prevented from substantially varying to reduce print quality.
